(19) United States
(12) Patent Application Publication
(10) Pub. No.: US 2010/0135244 A1
(43) Pub. Date: Jun. 3, 2010

(54) REDUCTION OF HANDOVER DELAYS IN NESTED PROXY MOBILE IPv6/MOBILE IPv6 NETWORKS

(75) Inventor: Desire Oulai, Longueuil (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 12/325,712

(22) Filed: Dec. 1, 2008

(51) Int. Cl. H04W 36/00

(52) U.S. Cl. 370/331

(57) ABSTRACT

A method for reducing handover delays of a mobile node moving from a first domain to a second domain, those domains being nested in a network, comprises, in a network node that manages connectivity between the first and second domains: establishing procedures for handover of the mobile node in the second domain, wherein establishing the procedures comprises receiving a binding request issued on behalf of the mobile node; and in response to the received binding request, establishing binding procedures in the first domain. Establishing the procedures for handover of the mobile node and the binding procedures occur in an overlapping manner. The network node for carrying such a method comprises a processing module for establishing procedures for handover in the second domain; and a binding processing module, responsive to the received binding request, for establishing binding procedures in the first domain. The processing and binding modules work in an overlapping manner.

### TECHNICAL FIELD

The present invention generally relates to nested mobile and proxy mobile IP networks. More specifically, the present invention is concerned with a method and system for reducing handover delays in such nested networks.

### BACKGROUND

Over the past few decades, telecommunications and Internet have experienced an incredible growth and expansion. Technologies have changed from centralized computing to personalized computing and now to mobile computing with a convergence of networks, devices and services.

Mobile computing is made possible through the use of Mobile IP or more specifically Mobile IPv6 (MIPv6), using the version 6 of Internet Protocol (IP). MIPv6 is an Internet Engineering Task Force (IETF) standard communication protocol. It has been designed to allow mobile users to move from one network to another without experiencing discontinuity of services. Indeed, MIPv6 protocol provides continuous IP services to a mobile node (MN), the mobile node being a mobile phone, a laptop or PDA, etc., by maintaining connectivity of the MN with different networks.

The mobility services are deployed through a Home Agent (HA) which provides a Home Address (HoA) to a MN registered with that HA. When the MN moves away and attaches itself to a different access router, it acquires a new address, called the Care-Of Address (CoA). The MN then sends a Binding Update (BU) to the HA in order to bind the CoA to the HoA, so that traffic directed to the HoA is forwarded to the CoA. The HA replies back to the MN with a Binding Acknowledgement (BA) and forwards each packet with HoA as destination address to the CoA using a bidirectional tunnel, for example. By so doing, the mobile node (MN) is able to move without ending ongoing sessions as the HoA of the MN remains unchanged.

However, there still exist mobile hosts that have not implemented MIPv6, for reasons, such as they do not want to or they cannot. For those hosts, a proxy version, called PMIP, has been developed. When using IPv6, the proxy mobile IP is referred to as PMIPv6.

PMIP has been designed for local mobility handling. The MN is connected to a Mobile Access Gateway (MAG) using a layer 2 access technology. The MAG is responsible for managing the mobility on behalf of the MN. In a PMIP domain, a Local Mobility Anchor (LMA) is also defined for distributing the Home Network prefixes (or addresses) and hiding the mobility from the external world, i.e. outside of the PMIP domain. The binding is performed by the MAG using a Proxy BU (PBU) and the LMA responds back with a Proxy BA (PBA). When moving into the PMIP domain, the concept of CoA is replaced by a Proxy CoA (PCoA), which is the address of the MAG with which the MN is registered. Once the binding process is completed, data packets are tunneled between the LMA and the MAG.

MIP offers global mobility and PMIP offers local mobility. More specifically, PMIP provides for network-based mobility management in the PMIP domain, i.e. the MAG manages the mobility on behalf of the MN. For this reason, it is common to see service operators using and deploying such PMIP domains.

Therefore, a current typical architecture consists of running MIP on top of PMIP so as to form a nested MIP/PMIP.

However, this current nested MIP/PMIP architecture generally presents a major drawback. Indeed, the delay involved during handovers of a MN toward a PMIP domain may be considerable and problematic. For example, before the MN is able to send a BU to the HA and thus to have access to the network, the MN has to wait for all the PMIP procedures to be first completed in the PMIP domain. This may take some time as the PMIP procedures may consist in authentication, PBU/PBA exchanges, PMIP tunnel setup, DHCP message exchanges, etc. During this time, data packets directed to the MN will be lost.

It should be noted that handover delays refer to the time that it takes before the MN can have connectivity in the new network.

Thus a general problem that needs to be overcome is to reduce the delay during which a MN is unreachable because of a handover involving nested networks architecture, such as a nested MIP/PMIP architecture for example.

### SUMMARY

More specifically, in accordance with the present invention, there is provided a method for reducing handover delays of a mobile node moving from a first domain to a second domain, the first and second domains being nested in a network. The method, in a network node that manages connectivity between the first domain and the second domain, comprises: establishing procedures for handover of the mobile node in the second domain, wherein establishing the procedures comprises receiving a binding request issued on behalf of the mobile node; and in response to the received binding request, establishing binding procedures in the first domain. Furthermore, establishing the procedures for handover of the mobile node in the second domain and establishing the binding procedures in the first domain occur in an overlapping manner.

According to another aspect of the present invention, there is provided a network node for reducing handover delays of a mobile node moving from a first domain to a second domain, the first and second domains being nested in a network. The network node comprises: a processing module for establishing procedures for handover in the second domain; wherein establishing the procedures comprises receiving a binding request issued on behalf of the mobile node; and a binding processing module, responsive to the received binding request, for establishing binding procedures in the first domain. The processing and binding modules work in an overlapping manner.

The foregoing and other aspects, advantages and features of the present invention will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 is a schematic view of a nested architecture according to a non-restrictive illustrative embodiment of the present invention;

FIG. 2 is a schematic block diagram of a network node used in the nested architecture of FIG. 1, according to the non-restrictive illustrative embodiment of the present invention;

FIG. 3 is a flow chart illustrating a method for reducing handover delays in the nested architecture of FIG. 1, according to the non-restrictive illustrative embodiment of the present invention; and

FIG. 4 is a flow chart illustrating the method of FIG. 3, for reducing handover delays in the nested architecture of FIG. 1, using a proxy token.

### DETAILED DESCRIPTION

Before going into the description of the non-restrictive illustrative embodiment of the present invention, it should be noted that the term MIP (or PMIP in the proxy case) can be used interchangeably with the term MIPv6 (or PMIPv6) without departing from the nature and scope of the present invention.

Even though the following description is given within the context of a nested MIP/PMIP architecture, it should be understood that the MIP/PMIP architecture represents only an example of nested architectures, having for example a first domain nested in a second domain, wherein the first domain includes the MIP domain and the second domain includes the PMIP domain. Embodiments of the present invention can be applied to other nested architectures of course.

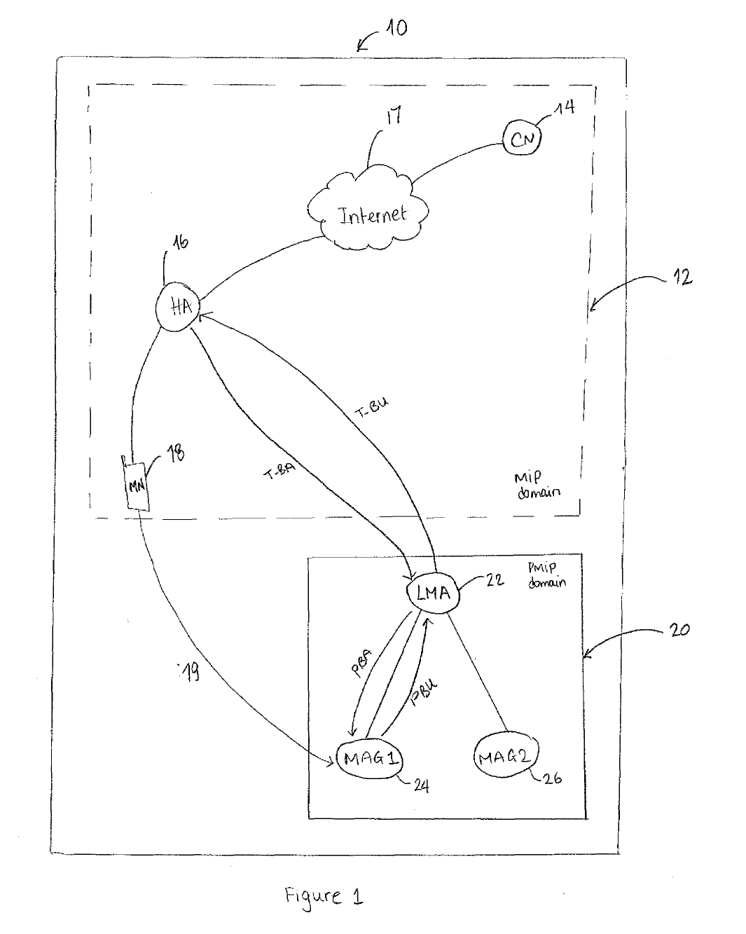

FIG. 1 illustrates a nested architecture, such as a MIP/PMIP architecture. As mentioned hereinabove, PMIP is designed for local mobility handling and MIP is more suitable for global mobility. Accordingly, as shown in FIG. 1, a nested MIP/PMIP architecture 10 has a MIP domain 12 running on top of a PMIP domain 20.

The nested MIP/PMIP architecture 10 of FIG. 1 will be now described in more detail.

The MIP domain 12 includes, for example, a correspondent node (CN) 14, connected to Internet 17 and a HA 16, in which the MN 18 is initially registered. The HA 16 can be a network node, which provides for mobility services of the MN 18, for example by assigning to the latter a home address.

The PMIP domain 20 includes a LMA 22, which is connected to a MAG1 24 and MAG2 26. It should be noted that the LMA 22 can be connected to a plurality of MAGs. The LMA 22 can be a network node that manages connectivity between the MIP domain 12 and the PMIP domain 20 as will be described hereinbelow. The MAGs can be access nodes to which the MN 18 can be attached.

More specifically, in this architecture 10, the MN 18 manages the global mobility, i.e. the MN 18 makes sure that the HA 16 is made aware of ways to reach the MN 18 and the MAGs 24 and 26 manage the local mobility in the PMIP domain 20, for example, as will be apparent thereafter. Furthermore, the nested PMIP/MIP architecture 10 can include more than one PMIP domain 20.

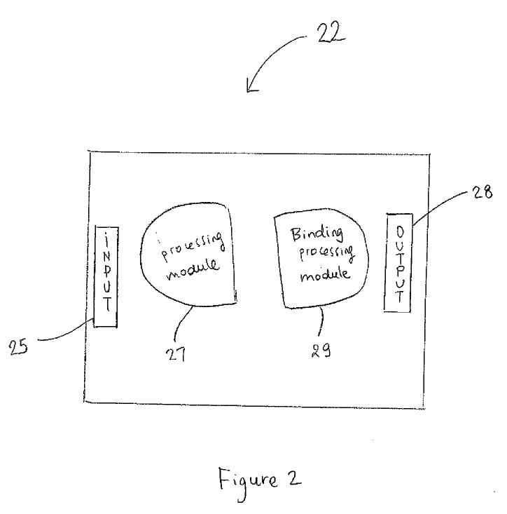

Now turning to FIG. 2, the network node, the LMA 22, will be described in more detail.

The LMA 22 includes an input 25, for receiving messages from the MAG1 24 or MAG2 26, for example. The LMA 22 also includes a processing module 27, a binding processing module 29 and an output 28.

The processing module 27 is used for establishing registration procedures in a domain for example. More specifically, the procedures can be the PMIP procedures for handover in the PMIP domain 20.

The binding processing module 29 is used to establish the binding procedures with the HA 16 in the MIP domain 12. For example, the output 28 allows for sending the binding update messages from the LMA 22 to the HA 16 in the MIP domain 12.

One way of performing a handover of the MN 18 moving from the MIP domain 12 to the PMIP domain 20, as shown by the arrow 19 of FIG. 1, is to follow a sequential procedure. For example, first the MN 18 attaches itself to the MAG1 24 and waits for all the PMIP procedures, such as authentication, PBU/PBA message exchanges and tunneling, to be completed. Then, after completion of the PMIP procedures, the MN 18 can initiate the binding procedures in the MIP domain 12, by sending a BU to the HA 16, for example. However, following this sequential procedure, the waiting period for the procedures in the PMIP domain 20 to be completed can incur considerable delays, during which all the data packets directed to the MN 18 are generally lost.

Generally stated, in a non-restrictive illustrative embodiment of the present invention, the procedures in the PMIP domain 20 and the binding procedures in the MIP domain 12 occur in an overlapping manner. More specifically, they can happen in parallel. Therefore, the delays incurred during handovers are reduced.

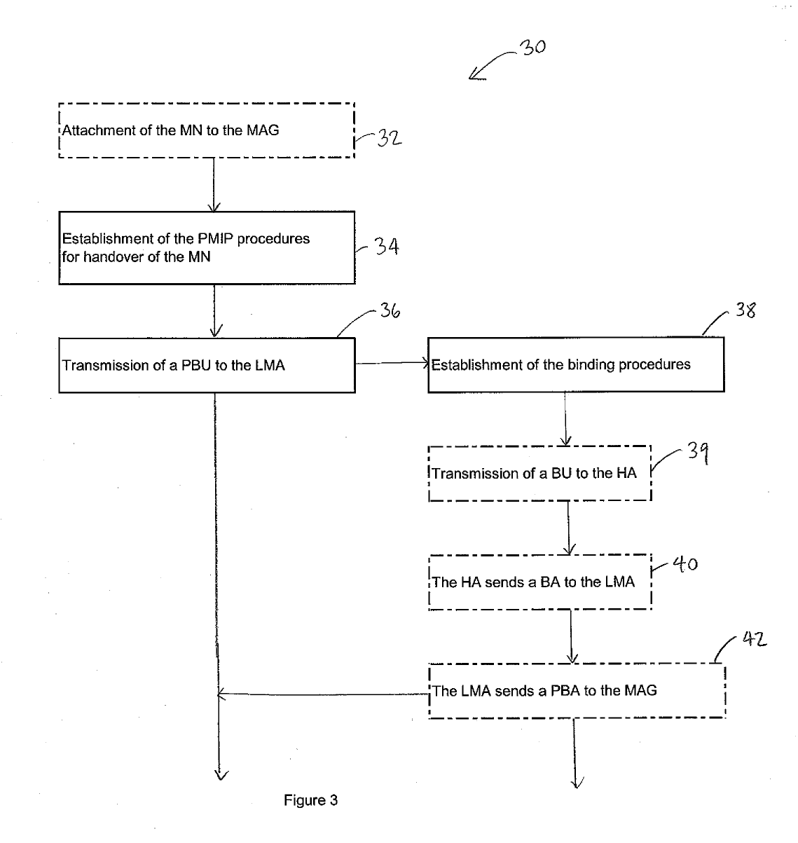

As mentioned already hereinabove, FIG. 1 shows a schematic view of the nested PMIP/MIP architecture 10. FIG. 2 shows a schematic view of the LMA 22. FIG. 3 is a flow chart illustrating a method for reducing the delays during handovers in the nested architecture 10, according to a non-restrictive illustrative embodiment of the present invention. It should be noted that in FIG. 3 the steps which are contained in the dashed boxes represent optional steps in the method.

Now, referring concurrently to FIGS. 1, 2 and 3, the method 30 for reducing delays in handovers of the MN 18, moving from the MIP domain 12 into the PMIP domain 20, for example, will be described.

In step 32, the MN 18 moves into the PMIP domain 20 and attaches itself to the MAG1 24.

Then, in step 34, establishment of the procedures, such as the PMIP procedures for handover of the MN 18 in the PMIP domain 20, are started through the processing module 27 in the LMA 22, for example.

More specifically, in step 36, the establishment of the procedures can start with the MAG1 24 sending a PBU to the LMA 22.

In step 38, upon receiving the PBU, the LMA 22 establishes the binding procedures with the HA 16.

More specifically, in step 39, the LMA 22 sends a BU to the HA 16 through the output 28, while continuing the PMIP procedures of the MN 18 in the PMIP domain 20. It should be noted that in order to be able to establish the binding procedures with the HA 16, some mechanisms should be in place, so that the HA 16 can recognize and/or authenticate the messages from the LMA 22, which are issued on behalf of the MN 18, for example. Also, it should be understood that establishing the procedures for handover of the MN 18 in the PMIP domain 20 and the binding procedures in the MIP domain 12 occur in an overlapping manner.

Also, due to authentication and security purposes, the BU sent by the LMA 22 can be a temporary BU, as will be described hereinbelow.

Next, in step 40, the HA 16 sends a BA to the LMA 22, upon receiving the BU and after going through the authentication mechanism. The BA sent by the HA 16 can also be a temporary BA, as will be described hereinbelow.

In step 42, the LMA 22 sends a PBA to the MAG1 24. It should be noted that in the context of the nested PMIP/MIP architecture 10 and as a best mode of method 30, step 42 is not optional. However, step 42 can be optional in other contexts of networks.

At this point, the MN 18 is ready to receive and send data packets related to its HoA.

Since the PMIP procedures and the binding procedures in the MIP domain 12 are performed in an overlapping manner, the waiting period of the MN 18 for receiving the BA from the HA 16 is reduced. Therefore, the number of data packets lost due to handover delays is also reduced.

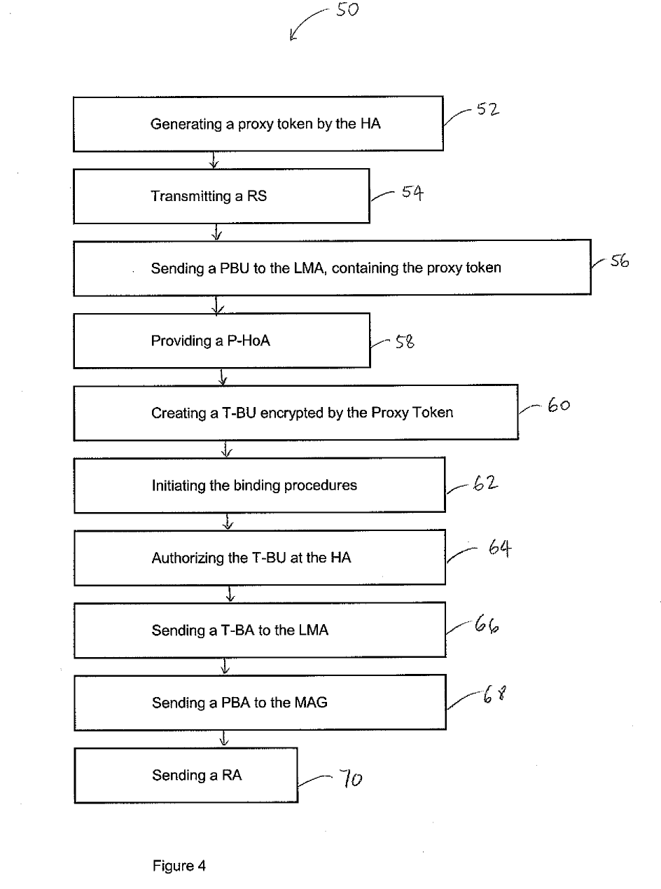

FIG. 4 illustrates an implementation example of the method 30 for reducing delays in handovers of the MN 18, moving from the MIP domain 12 into the PMIP domain 20, for example.

Referring concurrently to FIGS. 1, 2 and 4, the method 50 of FIG. 4 will be described now. More specifically, the method 50 uses a proxy token as the identification and/or authentication mechanism. Indeed, in order for the PMIP procedures and the binding procedures to happen in an overlapping manner, a security or authentication/identification mechanism should be in place between the MN 18, the LMA 22 and the HA 16. Of course, as will be explained hereinafter, it is within the scope and nature of the present invention to use other kinds of authentication mechanisms through special signaling, for example. Also, it is possible to use other kinds of indicators or proxy tokens, such as a key, a flag, an ID or any other signs for identification and/or authentication purposes and well-known by the persons skilled in the art.

While in the MIP domain 12 and before moving to the PMIP domain 20, the MN 18 has a MIPv6 connection with the HA 16, which provides the HoA to the MN 18.

In step 52 of method 50, the HA 16 can also generate a token or proxy token. The proxy token is generated before the handover, e.g., when the MN 18 moves away from the MIP domain 12 and attaches itself to the MAG1 24, using a layer 2 mechanism and protocol for example. The generated proxy token is then forwarded to the MN 18 through different ways. For example, the proxy token can be exchanged in a BU/BA message between the HA 16 and the MN 18. The proxy token can be also piggybacked in any encrypted data packets traveling between the MN 18 and the HA 16. Also, the generated proxy token can be refreshed, e.g., after the handover is complete.

In step 54, after the MN 18 is attached to the MAG1 24, the MN 18 can send a Router Solicitation (RS) message to the MAG1 24, requesting for router advertisements, for example. The RS message includes the Home Address (HoA) of the MN 18, the address of the HA 16 in which the MN 18 is registered and the proxy token generated by the HA 16. However, this step can be optional because the MN 18 can receive Router Advertisements (RA), which arrive spontaneously and automatically to the MN 18.

It should be noted that the MAG1 24 can also obtain the information contained in the RS message using other ways, such as retrieving these information from an AAA server during the authentication process of the MN 18, while it attaches to the MAG1 24. People skilled in the art will readily be able to use different ways to obtain the following information, the HoA of the MN 18, the address of the HA 16 and the proxy token.

In step 56, the MAG1 24 sends a PBU message to the LMA 22, which is received through the input 25 of the LMA 22. The sent PBU message comprises the HoA of the MN 18, the address of the HA 16 and the proxy token.

In step 58, the LMA 22 assigns, through the PMIP processing module 27, the address prefix necessary to form a Proxy Home Address (P-HoA) corresponding to the PMIP domain 20, to the MN 18. As an example, in 3GPP release 8, the LMA 22 provides the prefix and the Interface Identifier that are needed in order to form the P-HoA.

Once the P-HoA has been formed, the LMA 22 creates a BU message on behalf of the MN 18 in step 60. However, for security purposes, this BU message can be marked as a temporary BU (T-BU) message. Indeed, since the MIP domain 12 and the PMIP domain 20 are two different networks, end-to-end security measures should be applied. Until an end-to-end authentication and/or identification have not been performed, a temporary BU or temporary BA should be used. However, in the case where some pre-established security measures or mechanisms have been in place between the LMA 22 and the HA 16, a regular BU could be used.

The T-BU message contains, for example, the HoA and the P-HoA of the MN 18 as the CoA. Furthermore, the T-BU message is encrypted through the proxy token, generated by the HA 16. The proxy token acts as a security and/or authentication key, which protects the T-BU message. The T-BU message is then sent to the HA 16, through the output 28 of the LMA 22 so as to initiate the binding procedures in the MIP domain 20, in step 62. In parallel, the LMA 22 continues to perform the PMIP procedures for the handover operation of the MN 18 into the PMIP domain 20, the procedures comprising authentication, DHCP messages exchanges, etc. The PMIP procedures are performed through the PMIP processing module 27.

It should be understood that the PMIP procedures in the PMIP domain 20 can happen substantially in parallel with the binding procedures with the HA 16. Also, after the LMA 22 is made aware of the presence of the MN 18 in the PMIP domain 20, the LMA 22 can send the T-BU to the HA 14 any time as long as the PMIP procedures are not completed in the PMIP domain 20.

Furthermore, it should be also noted that by using the proxy token to encrypt the T-BU message, the T-BU message does not need any additional signaling or pre-established security procedures between the LMA 22 and the HA 16. Such additional signaling or security procedures, while it could contribute to increase the delay involved during the handovers, could still present an acceptable solution in the context of the present invention.

In step 64, after receiving the T-BU, the HA 16 authorizes the T-BU message by identifying the proxy token that was generated by the HA 16 in step 52. Next, the HA 16 updates the binding cache entry (T-BCE) for the MN 18 and makes it temporary. This T-BCE can be refreshed later on, but within a certain time interval by a regular BU, for example.

In step 66, the HA 16 responds to the LMA 22 with a BA or a temporary binding acknowledgment (T-BA) depending on the security measures that are already in place. The same conditions apply to the T-BA (or regular BA) as in the case of the T-BU (or a regular BU).

The LMA 22 responds to the MAG1 24 with a PBA in step 68.

For security purposes, the LMA 22 sends the PBA to the 24 after the LMA 22 receives the T-BA. In that case, the PBA can, furthermore, include an option to indicate that the MIP temporary binding is OK, upon receiving the T-BA from the HA 16, for example.

However, if security mechanisms have been pre-established between the different nodes of the nested architecture 10, such as the LMA 22, the HA 14 and the MAG1 24, the LMA 22 could send the PBA out before receiving the T-BA.

Once the PMIP procedures for handover in the PMIP domain 20 are completed, the MAG1 24 sends a Router Acknowledgement (RA) to the MN 18. The RA can include an option for indicating that the MIP Temporary binding is OK. This is done in step 70.

At this point, the MN 18 can send and receive data packets related to its HoA.

Furthermore, the MN 18 can send a regular BU to the HA 16 to confirm that the binding has been done, so that the HA 16 can update the T-BCE to become BCE, i.e. the binding is no longer temporary.

Also, the HA 16 can send a new proxy token to the MN 18 so as to refresh the currently used proxy token. This new proxy token can be used for the next handover.

It should be understood that during the PMIP procedures in the PMIP domain 20, data packets destined to the MN 18, would be generally lost since no binding between the MN 18 and the HA 16 has been performed yet. Therefore, during that time, the data packets cannot reach the MN 18; however, with the temporary BU/BA process, the time period where the data packets cannot reach the MN 18 during handovers is reduced, therefore delays incurred during handovers are reduced, i.e. there is no longer a need to wait for all the PMIP procedures to be completed first.

In the foregoing description, the case when the MN 18 moves from the MIP domain 12 into the PMIP domain 20 has been discussed. The non-restrictive illustrative embodiment of the present invention is not restricted to such a case, it can be applied to other nested situations, for example: when the MN 18 moves from a domain A to a domain B, both domains being nested in a domain C. Also, the embodiment of the present invention is not limited to the nested MIP/PMIP architecture 10, it can be applied to other nested connections and networks.

Although the present invention has been described in the foregoing specification by means of a non-restrictive illustrative embodiment, this illustrative embodiment can be modified at will within the scope and nature of the subject invention.

1. A method for reducing handover delays of a mobile node moving from a first domain to a second domain, the first and second domains being nested in a network, the method, in a network node that manages connectivity between the first domain and the second domain, comprising:
establishing procedures for handover of the mobile node in the second domain, wherein establishing the procedures comprises receiving a binding request issued on behalf of the mobile node; and
in response to the received binding request, establishing binding procedures in the first domain;
wherein establishing the procedures for handover of the mobile node in the second domain and establishing the binding procedures in the first domain occur in an overlapping manner.

2. A method as defined in claim 1, wherein the first domain comprises a MIP domain.

3. A method as defined in claim 1, wherein the second domain comprises a PMIP domain.

4. A method as defined in claim 1, further comprising generating an authentication key by a network node, which provides for mobility services to the mobile node.

5. A method as defined in claim 4, wherein generating the authentication key by the network node, which provides for mobility services to the mobile node, comprises generating a token.

6. A method as defined in claim 4, wherein generating the authentication key by the network node, which provides for mobility services to the mobile node, comprises generating a proxy token.

7. A method as defined in claim 6, wherein generating the proxy token further comprises forwarding the proxy token to the mobile node.

8. A method as defined in claim 7, wherein receiving the binding request comprises receiving a proxy binding update (PBU) from an access node, the PBU containing the proxy token forwarded to the mobile node.

9. A method as defined in claim 7, wherein establishing the procedures for handover of the mobile node comprises creating a proxy home address for the mobile node in the second domain.

10. A method as defined in claim 8, wherein establishing the binding procedures comprises creating a binding update (BU).

11. A method as defined in claim 10, wherein creating the BU comprises creating a temporary BU.

12. A method as defined in claim 11, wherein creating the temporary BU comprises encrypting the temporary BU with the proxy token.

13. A method as defined in claim 12, wherein establishing the binding procedures further comprises sending the temporary BU encrypted with the proxy token to the network node, which provides for mobility services to the mobile node, in the first domain.

14. A method as defined in claim 13, wherein establishing the binding procedures further comprises authorizing the temporary BU encrypted with the proxy token by the network node, which provides for mobility services to the mobile node.

15. A method as defined in claim 14, wherein establishing the binding procedures further comprises receiving a binding acknowledgment (BA) from the network node which provides for mobility services to the mobile node.

16. A method as defined in claim 15, wherein receiving the BA from the network node, which provides for mobility services to the mobile node, comprises receiving a temporary BA.

17. A method as defined in claim 8, wherein establishing the procedures for handover comprises sending a proxy BA to the access node.

18. A method as defined in claim 1, wherein establishing the procedures for handover of the mobile node further comprises authenticating the mobile node in the second domain.

19. A method as defined in claim 1, wherein establishing the procedures for handover of the mobile node in the second domain and establishing the binding procedures in the first domain occur substantially in parallel.

20. A network node for reducing handover delays of a mobile node moving from a first domain to a second domain, the first and second domains being nested in a network, the network node comprising:
a processing module for establishing procedures for handover of the mobile node in the second domain; wherein establishing the procedures comprises receiving a binding request issued on behalf of the mobile node; and
a binding processing module, responsive to the received binding request, for establishing binding procedures in the first domain;
wherein the processing and binding modules work in an overlapping manner.

21. A network node as defined in claim 20, wherein the first domain comprises a MIP domain.

22. A network node as defined in claim 20, wherein the second nested domain comprises a PMIP domain.

23. A network node as defined in claim 20, further comprising an input for receiving an identification key, generated by a network node, which provides for mobility services to the mobile node in the MIP domain.

24. A network node as defined in claim 23, wherein the received identification key comprises a proxy token.

25. A network node as defined in claim 24, wherein the input further receives a proxy BU from an access node, the proxy BU containing the proxy token.

26. A network node as defined in claim 25, wherein the processing module creates a proxy home address in the second domain, upon receiving the proxy BU.

27. A network node as defined in claim 26, wherein the binding processing module creates a BU encrypted with the received proxy token.

28. A network node as defined in claim 27, wherein the encrypted BU is a temporary encrypted BU.

29. A network node as defined in claim 28, wherein the binding processing module further transmits the temporary BU encrypted with the proxy token to the network node, which provides for mobility services to the MN in the first domain.

30. A network node as defined in claim 29, wherein the binding processing module further authorizes the temporary encrypted BU through the network node which provides for mobility services to the mobile node.

31. A network node as defined in claim 23, wherein the binding processing module further comprises receiving a BA from the network node which provides for mobility services to the mobile node, in the first domain.

32. A network node as defined in claim 23, wherein the binding processing module further comprises receiving a temporary BA from the network node which provides for mobility services to the mobile node.

33. A network node as defined in claim 25, wherein the processing modules sends a proxy BA to the access node.
